(19) United States
(12) Patent Application Publication
(10) Pub. No.: US 2010/0135006 A1
(43) Pub. Date: Jun. 3, 2010

(54) LED light group lamp

(76) Inventor: Ching-Chun Huang, Chu Pei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/591,330

(22) Filed: Nov. 17, 2009

(30) Foreign Application Priority Data
Dec. 1, 2008 (TW) 097221494

(51) Int. Cl. F21L 4/00

(52) U.S. Cl. 362/185

(57) ABSTRACT

An LED light group lamp includes a plurality of fixing portions criss-crossed and equidistantly disposed at a front side of a lamp holder, and a power supply module, installed at a back side of the lamp holder and electrically coupled to each fixing portion, and each LED light source is soldered, inserted, latched or screwed to the fixing portion, and the lamp holder includes a protective cover at a front side of the lamp holder. The modular design of the lamp not just significantly reduces the manufacturing cost only, but also facilitates the installation of the lamp to a general ceiling or a light steel frame as well as its maintenance and repair. Each LED light source can be replaced separately to lower the application cost, and the heat produced by each LED light source can be dissipated through the lamp holder and the fixture body to enhance the lifetime of the lamp.

### BACKGROUND OF THE INVENTION

1. Field of the Invention

The present invention relates to an illumination technology for indoor light sources, and more particularly to a modular light emitting diode (LED) light group lamp structure that combines an LED light source with a general lamp holder.

2. Description of the Related Art

In office and home, a light steel frame ceiling with the advantages of an easy construction, a neat and aesthetic appearance, and a replaceable panel is generally installed under the surface of a cement ceiling by suspension, and a sufficient space is usually reserved between the light steel frame ceiling and the cement ceiling for installing various different cables such as power cables, network cables and fire-fighting lines. To achieve a good light-collection performance, the light steel frame ceiling usually includes a specific lamp installed at the ceiling, and such lamp is light-weighted to comply with the requirement of the light steel frame ceiling.

With reference to FIG. 1 for the aforementioned conventional lamp, the lamp 1 comprises: a lamp holder 11, a power supply module 12, a plurality of fluorescent tubes 13 and a protective cover 14 installed at a front side of the lamp 1, wherein the lamp holder 11 includes a plurality of symmetrical electric connection support racks 15, and the power supply module 12 is installed at a back side of the lamp holder 11 for electrically coupling each electric connection support rack 15, and a fluorescent tube 13 is installed between any two electric connection support racks 15 for an electric conduction. Finally, the protective cover 14 is covered onto a front side of the lamp holder 11, wherein the protective cover 14 includes a plurality of ribs 141 criss-crossed with each other, and whose surface is coated with a layer of shinny film, so that the light of the fluorescent tube 13 can be reflected or refracted from the protective cover 14 to enhance the brightness and the illumination range.

Although the aforementioned conventional lamp 1 has the advantages of low cost and convenient maintenance, yet the fluorescent tube 13 also comes with the drawbacks of high power consumption and short lifetime. As a result, the overall cost of the conventional lamp is increased. In addition, another lamp designed with a long lifetime and a high-brightness LED fluorescent tube is available in the market to replace the conventional fluorescent tube 13, wherein the LED fluorescent tube includes an LED lamp panel, and the LED lamp panel includes a plurality of LED bulbs arranged in parallel rows and having the advantages of a high brightness and low heat generation rate. However, the LED fluorescent tube is of a high price, and a single LED bulb of the LED lamp panel cannot be repaired or replaced. Obviously, the conventional lamp 1 requires further improvements to achieve perfection.

### SUMMARY OF THE INVENTION

Therefore, it is a primary objective of the present invention to overcome the drawbacks of the prior art by providing a modular LED light group lamp, not only facilitating convenient installation, maintenance and repair only, but also lowering the manufacturing and application costs of the lamp.

Another objective of the present invention is to provide a convenient-to-replace LED light source for lowering the application cost of the lamp.

A further objective of the present invention is to provide a lamp holder for enhancing the heat dissipation effect of the LED light sources, so as to improve the illumination effect and extend the lifetime of the lamp.

To achieve the foregoing objectives, the present invention provides an LED light group lamp, comprising a lamp holder, a plurality of LED light sources, a power supply module and a protective cover, wherein the lamp holder includes a plurality of fixing portions disposed equidistantly at a front side of the lamp holder and criss-crossed with each other, and each LED light source is fixed onto the fixing portion by a soldering, inserting, latching or screwing method, and the lamp holder includes a power supply module disposed onto a back side of the lamp holder and electrically coupled to each fixing portion for electrically conducting the LED light source with the power supply module, and the lamp holder further includes a protective cover with a plurality of compartments installed at a front side of the lamp holder, and a shinny film is coated onto a surface of the protective cover, or the protective cover is a made of a transparent glass or acrylic panel to constitute a modular LED light group lamp.

In an application of the lamp, each LED light source is disposed in the compartment of the protective cover, and the compartment is designed in a way that the light of each LED light source can be focused to prevent the light of the LED light source from forming light spots or being diffused too much to cause a glare problem. In addition, the modular structure of the present invention is installed directly to an installation hole of a general light steel frame ceiling, so that the invention can save the electric connection support rack required by the conventional lamp by soldering the structure or inserting the structure into an insert slot instead to lower the manufacturing cost significantly. If a single LED light source is damaged, the LED light source can be repaired or replaced individually, and thus the invention provides a simple and easy way of replacing the LED light sources to lower the cost of using the lamp. Since each LED light source of the present invention is fixed directly onto the lamp holder with a direct contact, therefore a large-area metal design of the lamp holder and the fixture body can be used for dissipating heat to enhance the effects of using the lamp and extending the lifetime of the LED light sources.

### BRIEF DESCRIPTION OF THE DRAWINGS

FIG. 1 is a perspective exploded view of a conventional lamp;

FIG. 2 is a perspective exploded view of a preferred embodiment of the present invention;

FIG. 3 is a perspective assembled view of a preferred embodiment of the present invention;

FIG. 4 is a first schematic view of an assembly in accordance with a preferred embodiment of the present invention;

FIG. 5 is a second schematic view of an assembly in accordance with a preferred embodiment of the present invention;

FIG. 6 is a third schematic view of an assembly in accordance with a preferred embodiment of the present invention;

FIG. 7 is a fourth schematic view of an assembly in accordance with a preferred embodiment of the present invention;

FIG. 8 is a fifth schematic view of an assembly in accordance with a preferred embodiment of the present invention;

FIG. 9 is a perspective view of another type of lamp holder in accordance with a preferred embodiment of the present invention;

FIG. 10 is a perspective view of a further type of lamp holder in accordance with a preferred embodiment of the present invention;

FIG. 11 is a perspective view of a hanging lamp manufactured in accordance with a preferred embodiment of the present invention;

FIG. 12 is a perspective view of a ceiling mounted lamp manufactured in accordance with a preferred embodiment of the present invention; and

FIG. 13 is a perspective view of another LED light source of a preferred embodiment of the present invention.

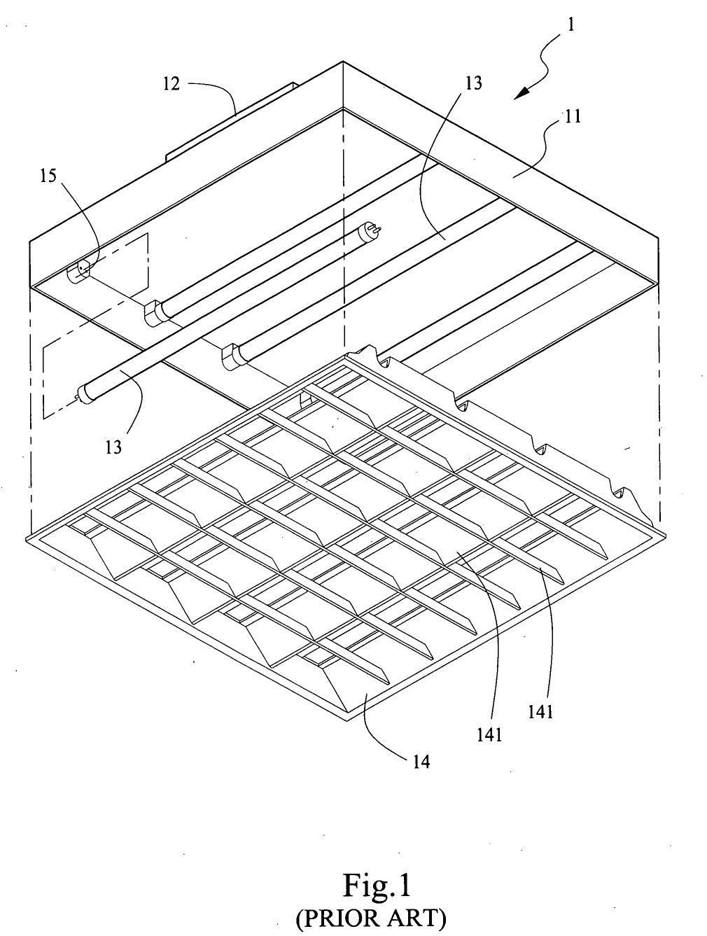

### DETAILED DESCRIPTION OF THE PREFERRED EMBODIMENTS

The technical characteristics of the present invention will become apparent with the detailed description of the preferred embodiments and the illustration of the related drawings as follows.

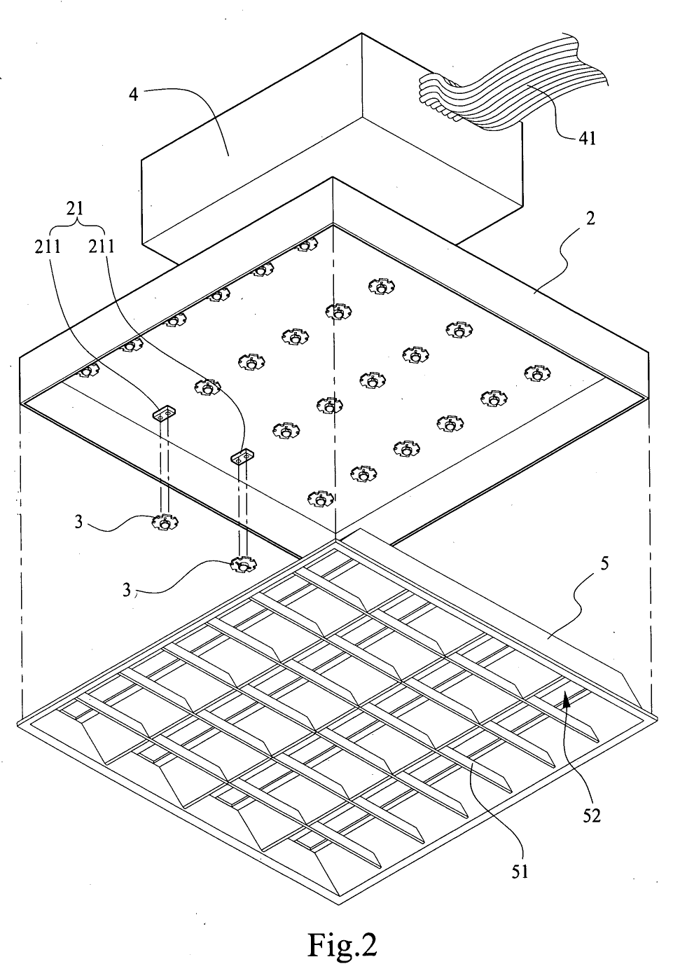

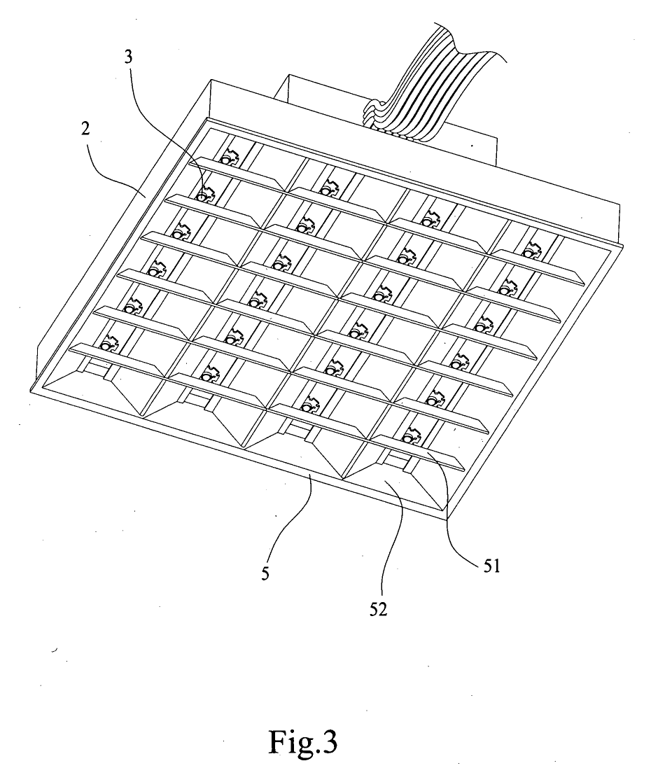

With reference to FIGS. 2 to 8, an LED light group lamp of the present invention comprises:

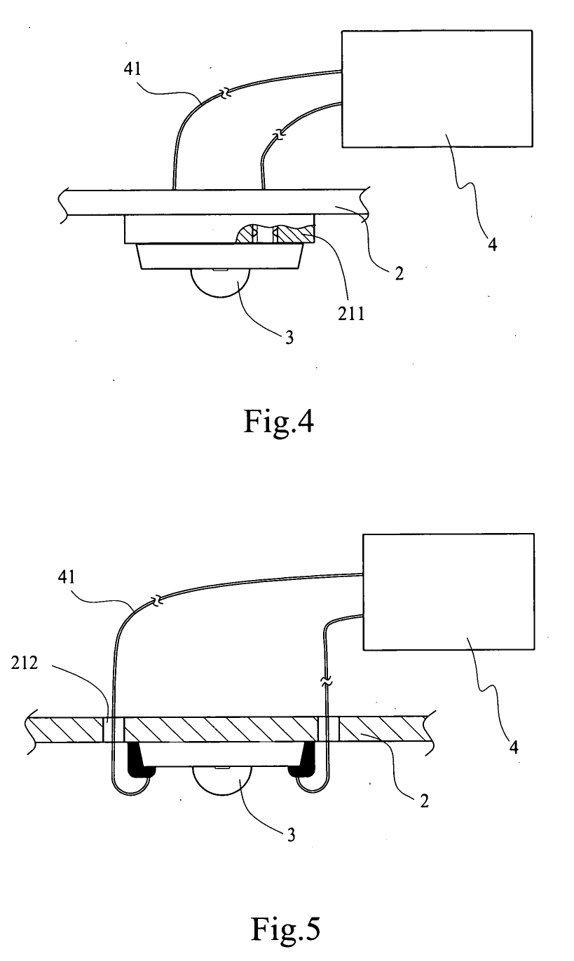

a lamp holder 2, having a front side substantially in the shape of a panel, whose surface is coated with a shinny film and includes a plurality of fixing portions 21 equidistantly arranged and criss-crossed with each other, wherein a fixed interval is maintained from the fixing portion 21 as shown in FIG. 4, and the fixing portion 21 is in the form of an insert slot 211;

a plurality of LED light sources 3, each being disposed on and can be plugged into each fixing portion 21 as shown in FIG. 4, for an easy maintenance and repair;

a power supply module 4, installed at a back side of the lamp holder 2, and electrically coupled to each fixing portion 21 (wherein a connecting cable 41 is connected to a rear end of the insert slot 211), such that after the LED light source 3 is plugged into the fixing portion 21, the power supply module 4 and each LED light source 3 are electrically conducted, wherein the power supply module 4 has the functions of converting voltage, stabilizing current and electrically coupling an external power supply (not shown in the figure); and

a protective cover 5, covered onto a front side of the lamp holder 2, and having a plurality of ribs 51 criss-crossed with each other to form a plurality of parallelly arranged compartments 52, wherein each compartment 52 corresponds to LED light source 3, and a bright film is coated onto a surface of the protective cover 5.

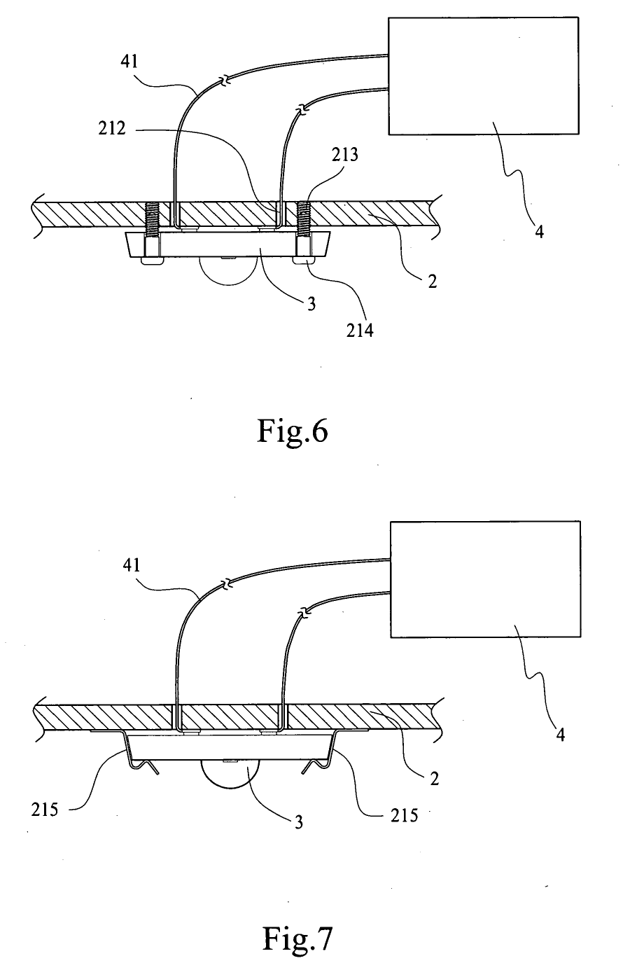

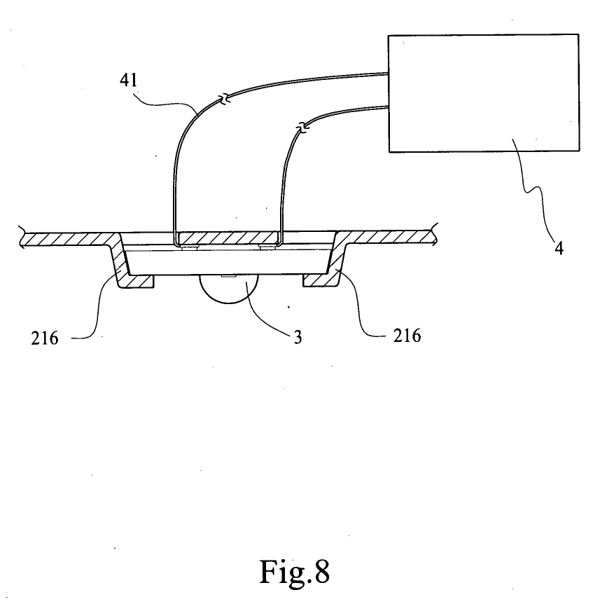

In summation of the description above, the fixing portion 21 provided for fixing the LED light source 3 includes the following types: The fixing portion 21 as shown in FIG. 4 is an insert slot 211 provided for plugging the LED light source 3, and a rear end of the fixing portion 21 is electrically coupled with the power supply module 4 by the connecting cable 41. This type of fixing portion 12 provides a convenient way of maintaining and repairing the LED light sources 3, and is also a preferred embodiment of the present invention. Alternatively, the fixing portion 12 as shown in FIG. 5 includes a threading hole 212 for soldering the LED light source 3 and the connecting cable 41 of the power supply module 4 onto a surface of the lamp holder 2, or the fixing portion 21 as shown in FIG. 6 includes a threading hole 212 and a pair of screw holes 213, wherein the threading hole 212 is provided for passing the connecting cable 41 of the power supply module 4 to connect the LED light source 3, and then the LED light source 3 is fixed to a surface of the lamp holder 2 by a screw 214, or the fixing portion 21 as shown in FIG. 7 includes a threading hole 212 and a pair of elastic slices 215 for passing the connecting cable 41 of the power supply module 4 to connect the LED light source 3, and then the elastic slice 215 is used for latching and fixing the LED light source 3 onto a surface of the lamp holder 2, or the fixing portion 21 as shown in FIG. 8 includes a threading hole 212 and a plurality of hooks 216 disposed around the periphery of the threading hole 212 and corresponding to the LED light source 3, wherein the hooks 216 are protruded from a surface of the lamp holder 2, and the threading hole 212 are provided for passing the connecting cable 41 of the power supply module 4 to connect the LED light source 3, and then the hooks 216 are latched and fixed to the periphery of the LED light source 3.

When installed, the modular structure of the present invention designed specifically for a general light steel frame ceiling can be installed directly into an installation hole of the light steel frame ceiling to replace the conventional lamp directly, and thus the modular design can lower the manufacturing cost significantly. In FIG. 4, each LED light source 3 of the present invention is installed in each independent compartment 52 of the protective cover 5, and each compartment 52 has a refractive angle designed for focusing and collecting the light of each LED light source 3 in order to prevent a diffusion of the light or an insufficient brightness, and also avoid a formation of light spots by the light of the LED light source 3. In addition, the manufacturing cost of single LED light sources 3 is low. Since a damaged single LED light source 3 can be repair or replaced directly, the cost of replacing the single LED light sources 3 can be lowered.

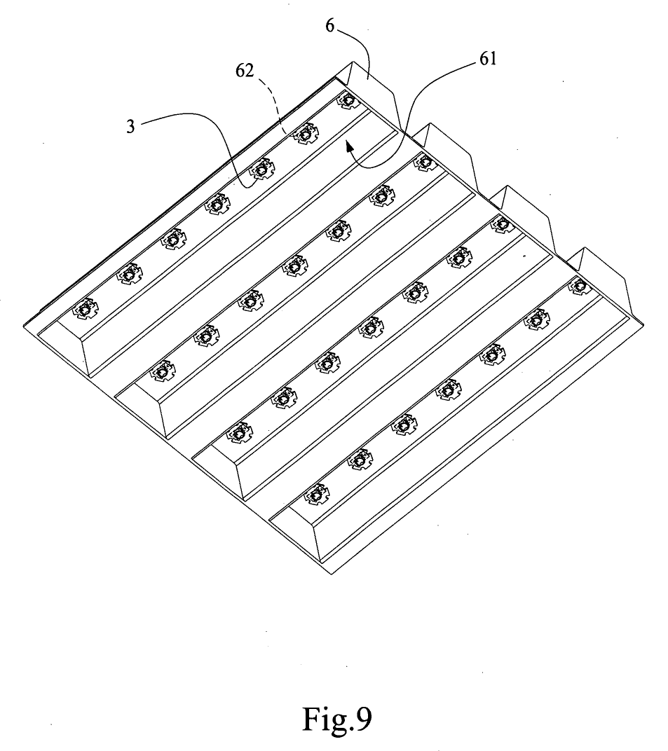

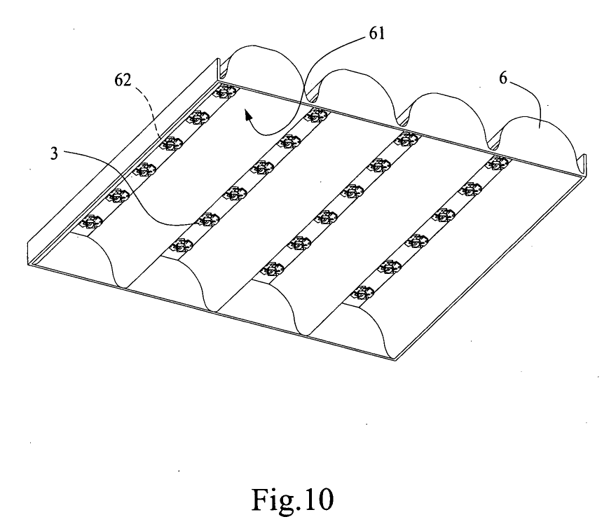

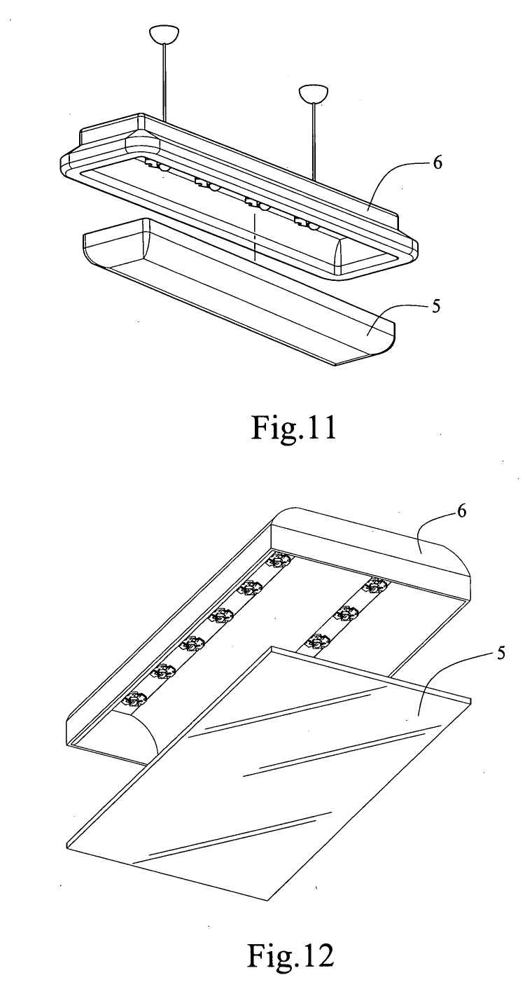

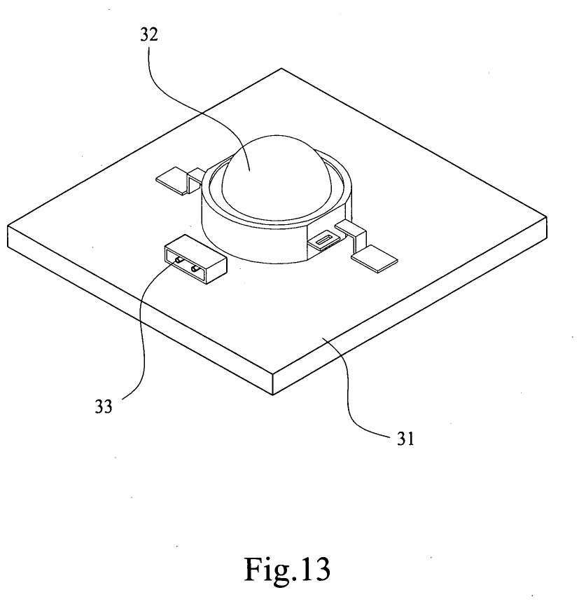

With reference to FIGS. 9 and 10, the lamp holder 6 further includes a plurality of grooves 61 formed at a front side of the lamp holder 6 to improve the focusing, refracting and reflecting effects, wherein the grooves 61 are arranged in parallel with each other (refer to FIG. 9 for a rectangular groove 61 and FIG. 10 for a wavy groove 61), and each groove 61 includes a plurality of fixing portions 62 for fixing the LED light sources 3 respectively. In addition, the aforementioned design can simplify the design of the protective cover 5 as shown in FIGS. 11 and 12, wherein a transparent glass or acrylic material is used for producing the protective cover 5 substantially in the shape of a panel covered onto the front side of the lamp holder 6 to form a hanging or ceiling mounted lamp. With reference to FIG. 13 for a perspective view of another LED light source in accordance with a preferred embodiment of the present invention, the LED light source 3 further comprises a circuit board 31, an LED 32 and an electric connector 33, the LED 3 and the electric connector 33 are installed at the center and a side of the circuit board 31 respectively, and the LED 32 is electrically coupled to the electric connector 33, and the electric connector 33 is provided for electrically coupling the connecting cable 41 of the power supply module 4 to supply electric power required for operating the LED 32, and the LED light source can be installed and removed easily.

In summation of the description above, the embodiments of the present invention as shown in FIGS. 2 to 13 have the following advantages:

1. The lamp holder 2, LED light sources 3, power supply module 4 and protective cover 5 of the present invention come with a modular design to lower the manufacturing cost significantly, and the heat produced by the LED light sources 3 can be dissipated through the lamp holder 2 and the fixture body 5 to improve the effects of using the lamp and extending the life of the LED light sources 3.

2. Since the fixing portion 21 of the present invention can be plugged, screwed or latched to the LED light sources 3 to maintain an electric conduction state, any damaged LED light source 3 can be removed and replaced quickly, so as to lower the cost of repairing the LED light source 3.

3. The lamp holder 6 of the present invention can be designed as a rectangular groove 61 or a wavy groove 61 for adjusting the reflective or refractive angle of the LED light source 3 to control the brightness and illumination range of the light.

4. The lamp of the present invention can be designed as a hanging lamp or a ceiling mounted lamp to provide an easy installation to any place.

What is claimed is:

1. A light emitting diode (LED) light group lamp, comprising:
a lamp holder, having a plurality of fixing portions equidistantly disposed a front side of the lamp holder and criss-crossed with each other;
a plurality of LED light sources, disposed on the fixing portion;
a power supply module, disposed at a back side of the lamp holder, and electrically coupled to each fixing portion, for electrically conducting the power supply module and each LED light source;
a protective cover, covered onto the front side of the lamp holder, for covering the LED light sources.

2. The LED light group lamp of claim 1, wherein each fixing portion is an insert slot provided for inserting the corresponding LED light source.

3. The LED light group lamp of claim 1, wherein the fixing portion includes a threading hole for passing a connecting cable of the power supply module to electrically couple the corresponding LED light source.

4. The LED light group lamp of claim 1, wherein each fixing portion includes a threading hole and a pair of elastic slices for passing a connecting cable of the power supply module to connect the LED light source, and the elastic slices are provided for securing the LED light source onto a surface of the lamp holder.

5. The LED light group lamp of claim 1, wherein the lamp holder includes a plurality of grooves arranged in parallel with each other, and each groove further includes a plurality of fixing portions.

6. The LED light group lamp of claim 5, wherein each fixing portion is an insert slot for installing the LED light source.

7. The LED light group lamp of claim 5, wherein the fixing portion includes a threading hole for passing a connecting cable of the power supply module to electrically couple the LED light source.

8. The LED light group lamp of claim 5, wherein the fixing portion includes a threading hole for passing a connecting cable of the power supply module to couple the LED light source, and a pair of elastic slices for securing the LED light-source onto a surface of the lamp holder.

9. The LED light group lamp of claim 1, wherein the protective cover includes a plurality of ribs criss-crossed with each other to form a plurality of parallel compartments, and each compartment corresponds to each LED light source, and the protective cover further includes a shinny film coated onto a surface of the protective cover.

10. The LED light group lamp of claim 1, wherein the protective cover is a panel structure made of a transparent material.
